(19) United States
(12) Patent Application Publication
(10) Pub. No.: US 2013/0139113 A1
(43) Pub. Date: May 30, 2013

(54) QUICK ACTION FOR PERFORMING FREQUENT TASKS ON A MOBILE DEVICE

(71) Applicants: Bibhu Choudhary, Hyderabad-IDC (IN); Nizam Ahmed, Hyderabad-IDC (IN); Purushottam Raj, Hyderabad-IDC (IN); Ashwani Kumar, Hyderabad-IDC (IN); Sachin Jindal, Hyderabad-IDC (IN)

(72) Inventors: Bibhu Choudhary, Hyderabad-IDC (IN); Nizam Ahmed, Hyderabad-IDC (IN); Purushottam Raj, Hyderabad-IDC (IN); Ashwani Kumar, Hyderabad-IDC (IN); Sachin Jindal, Hyderabad-IDC (IN)

(73) Assignee: MICROSOFT CORPORATION, Redmond, WA (US)

(21) Appl. No.: 13/308,069

(22) Filed: Nov. 30, 2011

(51) Int. Cl. G06F 3/048

(52) U.S. Cl. 715/847

(57) ABSTRACT

A shortcut is created that groups and sequences actions to perform a task. A user may record actions both within an application and outside of an application to perform the task. For example, a user may record launching an application, accessing an item within the application, and performing one or more actions that involve the item. An Application Programming Interface (API) may be used by one or more applications to specify recordable actions that are associated with the application. For example, an application may specify that configuration settings for the application are not recordable while other user actions are recordable. After recording the actions for the task, a shortcut is created. The shortcut may be accessible from a home display of a mobile device (e.g. a start screen of a smart phone) and/or some other accessible location.

### BACKGROUND

Many users repeatedly perform the same tasks on a computing device. For example, a user may frequently access a messaging program and create a new message that is addressed to members of their team. A user may access a notes program and create a new note. A user may also access other applications and perform other operations. Performing these actions on a mobile computing device, such as a smart phone, however, may be cumbersome since input methods on mobile computing devices are limited.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A shortcut is created that groups and sequences actions to perform a task. A user may record actions both within an application and outside of an application to perform the task. For example, a user may record launching an application, accessing an item within the application, and performing one or more actions that involve the item. An Application Programming Interface (API) may be used by one or more applications to specify recordable actions that are associated with the application. For example, an application may specify that configuration settings for the application are not recordable while other user actions are recordable. After recording the actions for the task, a shortcut is created. The shortcut may be accessible from a home display of a mobile device (e.g. a start screen of a smart phone) and/or some other accessible location.

### BRIEF DESCRIPTION OF THE DRAWINGS

FIG. 1 illustrates an exemplary computing device;

FIG. 2 illustrates an exemplary system for recording and using shortcuts;

FIG. 3 shows a process for creating and using a shortcut;

FIG. 4 illustrates a process for recording a shortcut;

FIG. 5 illustrates a system architecture for creating and interacting with shortcuts;

FIG. 6 shows exemplary displays that illustrate creating a shortcut; and

FIG. 7 shows exemplary displays that illustrate editing a shortcut.

### DETAILED DESCRIPTION

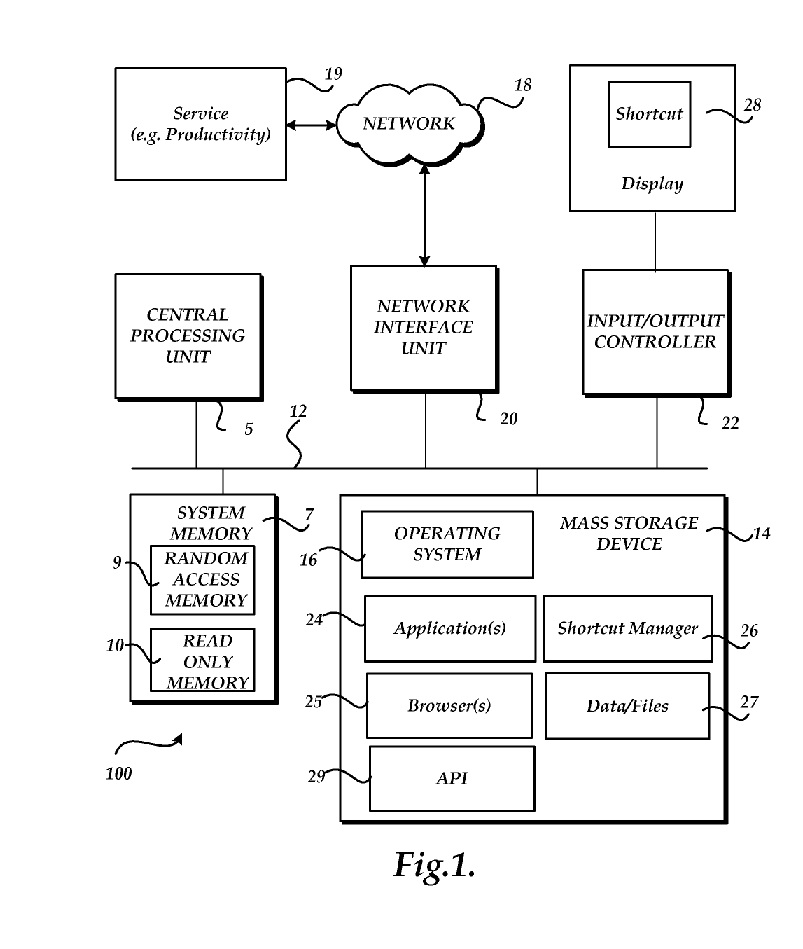

Referring now to the drawings, in which like numerals represent like elements, various embodiments will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured as a server computing device, a desktop computing device, a mobile computing device (e.g. smartphone, notebook, tablet . . . ) and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, application(s) 24, data/file(s) 27, and other program modules, such as Web browser 25, and shortcut manager 26, which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, computer 100 may operate in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, such as a touch input device. The touch input device may utilize any technology that allows single/multi-touch input to be recognized (touching/non-touching). For example, the technologies may include, but are not limited to: heat, finger pressure, high capture rate cameras, infrared light, optic capture, tuned electromagnetic induction, ultrasonic receivers, transducer microphones, laser rangefinders, shadow capture, and the like. According to an embodiment, the touch input device may be configured to detect near-touches (i.e. within some distance of the touch input device but not physically touching the touch input device). The touch input device may also act as a display 28. The input/output controller 22 may also provide output to one or more display screens, a printer, or other type of output device.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

Embodiments of the invention may be practiced via a system-on-a-chip (SOC) where each or many of the components/processes illustrated in the FIGURES may be integrated onto a single integrated circuit. Such a SOC device may include one or more processing units, graphics units, communications units, system virtualization units and various application functionality all of which are integrated (or “burned”) onto the chip substrate as a single integrated circuit. When operating via a SOC, all/some of the functionality, described herein, may be integrated with other components of the computer 100 on the single integrated circuit (chip).

As mentioned briefly above, a number of program modules and data files may be stored in the mass storage device 14 and RAM 9 of the computer 100, including an operating system 16 suitable for controlling the operation of a computer, such as the WINDOWS SERVER®, WINDOWS 7® operating systems from MICROSOFT CORPORATION of Redmond, Wash.

The mass storage device 14 and RAM 9 may also store one or more program modules. In particular, the mass storage device 14 and the RAM 9 may store one or more applications, such as a shortcut manager 26, applications 24 (e.g. a spreadsheet application such as MICROSOFT EXCEL, a presentation application such as MICROSOFT POWERPOINT, a word-processing application such as MICROSOFT WORD, a messaging application such as MICROSOFT OUTLOOK, a graphics application, and the like), and may store one or more Web browsers 25. The Web browser 25 is operative to request, receive, render, and provide interactivity with electronic content, such as Web pages, videos, documents, and the like. According to an embodiment, the Web browser comprises the INTERNET EXPLORER Web browser application program from MICROSOFT CORPORATION.

Shortcut manager 26 may be located on a client device and/or on a server device (e.g. within service 19). Shortcut manager 26 may be configured as an application/process and/or as part of a cloud based multi-tenant service that provides resources (e.g. services, data . . . ) to different tenants (e.g. MICROSOFT OFFICE 365, MICROSOFT WEB APPS, MICROSOFT SHAREPOINT ONLINE).

Generally, shortcut manager 26 is configured to create shortcuts that group and sequence actions to perform tasks. A user may record actions within an application and outside of an application to perform the task. For example, a user may record launching an application 24, opening a new message within the application, and performing one or more actions with the newly opened message (e.g. addressing the message). An Application Programming Interface (API) 29 may be used by one or more applications 24 to specify recordable actions that are associated with the application. For example, an application may specify that configuration settings for the application are not recordable while other user actions are recordable. Applications may expose all/portion/none of the actions that are associated with the application. After a user has recorded the actions for the task, a shortcut is created. The shortcut may be accessible from a home display of a mobile device (e.g. a start screen of a smart phone) and/or some other accessible location. In response, to the shortcut being selected, the recorded actions are performed. Additional details regarding the operation of shortcut manager 26 will be provided below.

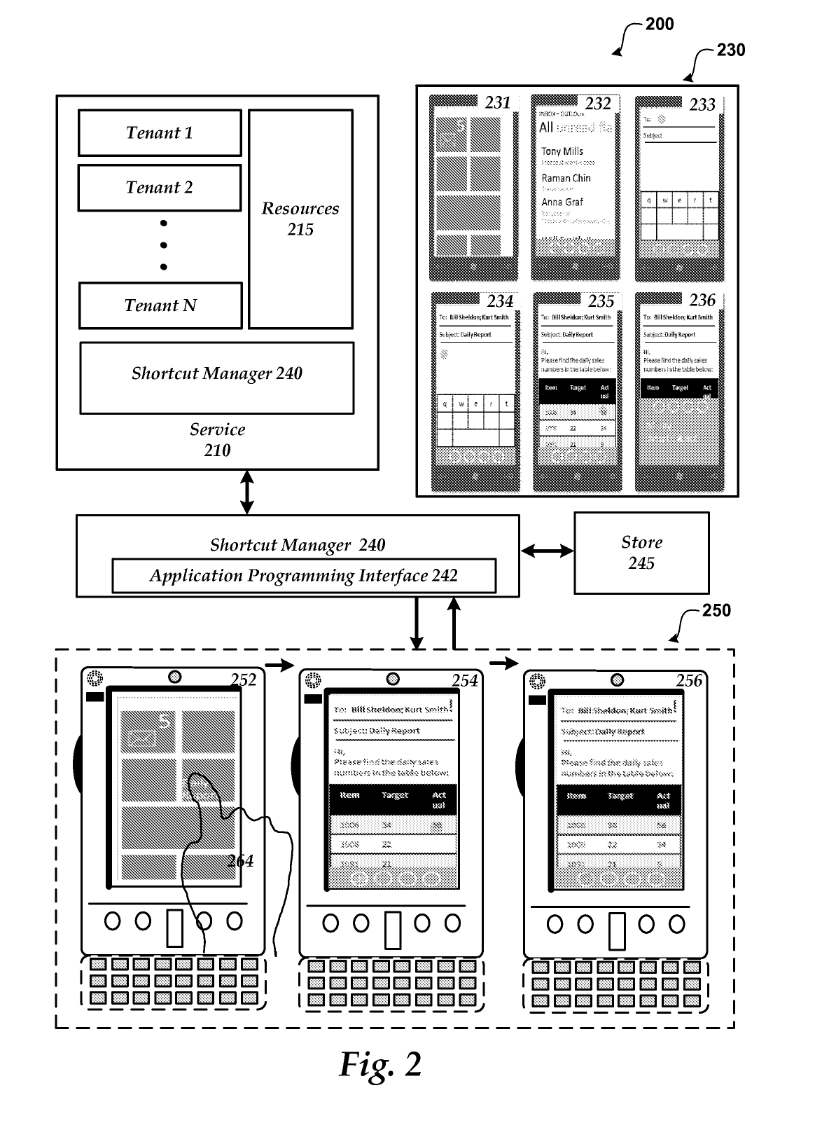

FIG. 2 illustrates an exemplary system for recording and using shortcuts. As illustrated, system 200 includes service 210, shortcut manager 240, store 245, and touch screen input device/display 250 (e.g. smartphone).

As illustrated, service 210 is a cloud based and/or enterprise based service that may be configured to provide one or more services (e.g. MICROSOFT OFFICE 365, MICROSOFT WEB APPS, MICROSOFT POWERPOINT). Functionality of one or more of the services/applications provided by service 210 may also be configured as a client based application. For example, a client device may include one or more applications (e.g. productivity applications, news applications, movie applications, travel applications, search applications, consumer applications, mapping applications, and the like).

As illustrated, service 210 is a multi-tenant service that provides resources 215 and services to any number of tenants (e.g. Tenants 1-N). According to an embodiment, multi-tenant service 210 is a cloud based service that provides resources/services 215 to tenants subscribed to the service and maintains each tenant's data separately and protected from other tenant data.

System 200 as illustrated comprises a touch screen input device/display 250 (e.g. a smart phone 250) that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

As illustrated, touch screen input device/display 250 shows three exemplary displays 252, 254 and 256 showing the use of a shortcut. Shortcut manager 240 is configured to receive and process input/actions to create/edit/start a shortcut. A user may create a shortcut that groups and sequences actions to perform a task by recording actions and/or editing actions. A user may record actions within an application and outside of an application to perform the task. In the current example, a user has created a “Daily Report” shortcut (see display 252) that when selected by a user (e.g. user 264) launches a messaging application, automatically addresses a new message, automatically places the subject in the message, and automatically fills out a portion of the message body.

Creating a shortcut is directed at reducing a number of actions that are performed by a user. In the current example, without using a shortcut, the user would have to perform many more actions (see box 230 that includes exemplary displays without using a shortcut). The user would have to locate the messaging application and then launch the application (231). The user would then locate the user interface option to create a new message (232). After the new message is displayed (233), the user would then address the message by typing/selecting the names (234), type in a subject (234), fill out the body of the message (235) and perform other actions (236) with the message (e.g. prioritize the message, include a table, . . . ).

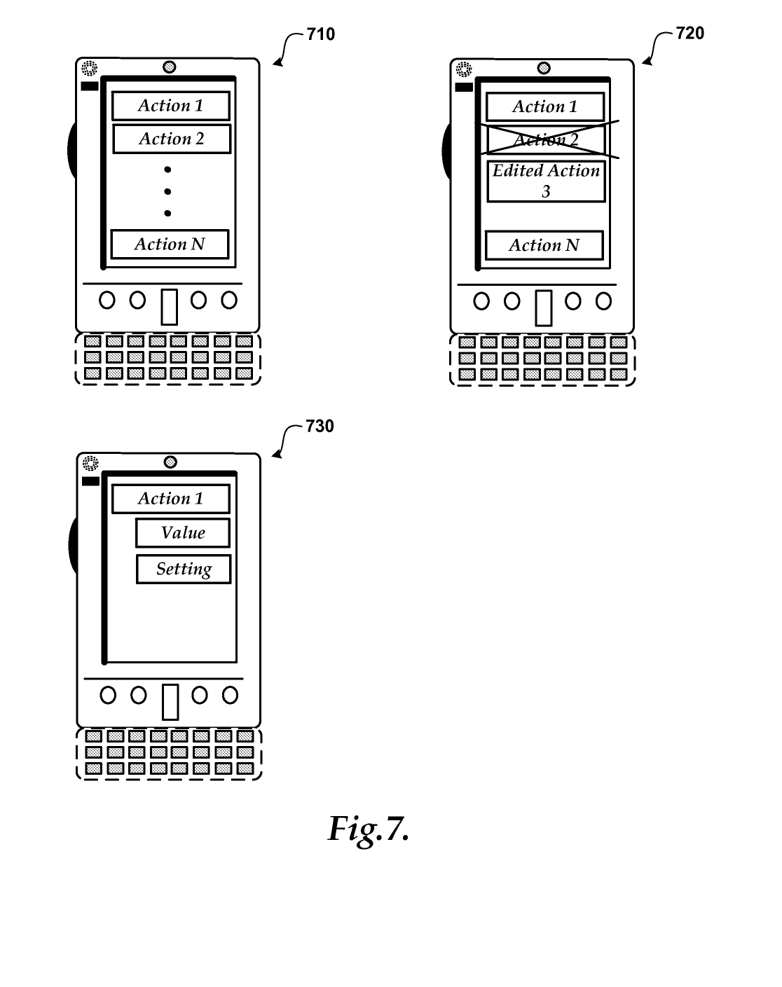

In order to automate all/portion of these actions, a shortcut may be created. For example, the user may record the sequence of actions illustrated in box 230. Shortcut manager 240 may record the actions and create the shortcut. An Application Programming Interface (API) may be used by one or more applications to specify recordable actions that are associated with the application. For example, an application may specify that some actions that are associated with an application are not recordable, whereas other actions are recordable. The shortcut may be named (e.g. “Daily Report”) and may be edited. For example, a user interface may be displayed that allows a user to change an ordering of the actions, add/delete actions, set parameters and the like (See FIG. 7 and related discussion). The shortcut may be manually/automatically positioned within the display. For example, a user may specify that the shortcut be placed on the start screen (e.g. first screen of a device) or some other display screen of the device (e.g. 2^{nd} screen, 3^{rd} screen, . . . ).

The shortcut may be stored on the device (e.g. store 245) and/or at an external location (e.g. service 210). In response to selecting the shortcut, the recorded actions that are associated with the shortcut are performed. Display 252 shows the initial selection of the shortcut. Display 254 shows the initial screen 254 that is displayed after selecting the Daily Report shortcut. As can be seen, the message is addressed, the subject is filled out and a portion of the message is created. The user is able to edit the message (e.g. fill out the actual values for the day (see display 256)) and then the user can send the message. Instead of taking six or more steps to create a message, the shortcut creates the message in two steps (selecting the shortcut and changing data in the message). More details regarding the creation and use of shortcuts is provided below.

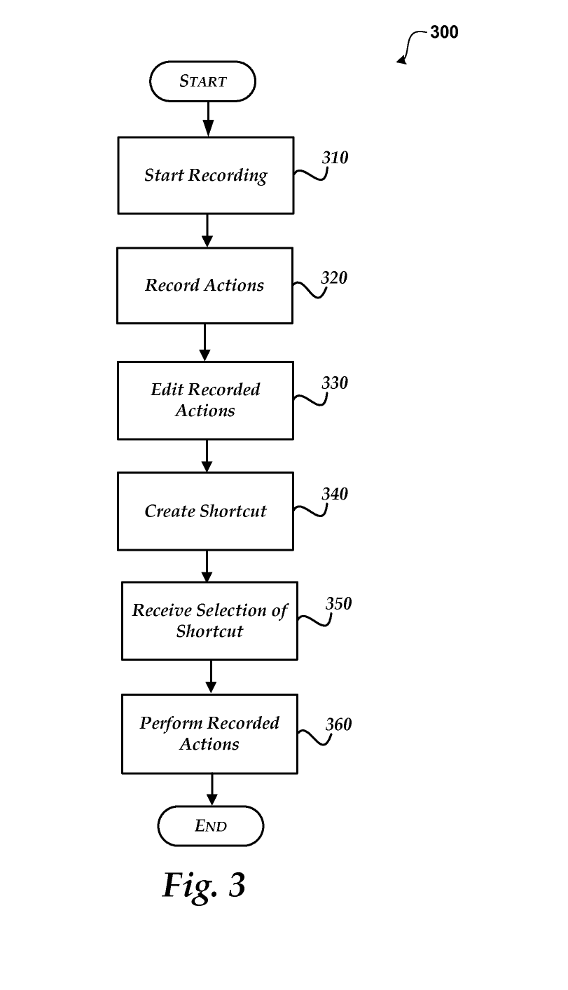

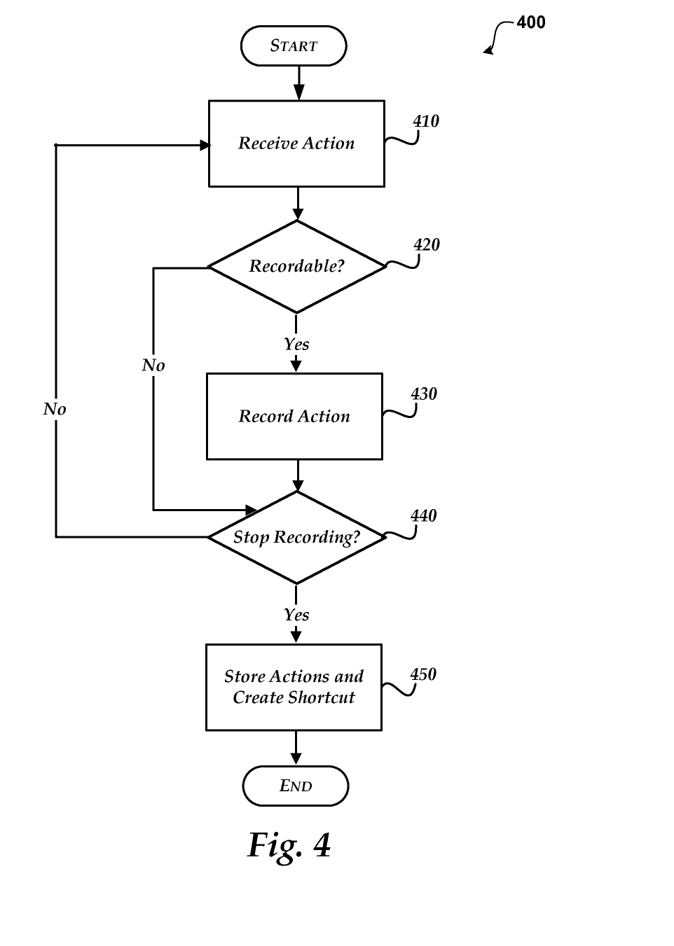

FIGS. 3-4 show an illustrative process for creating and using shortcuts. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof. While the operations are shown in a particular order, the ordering of the operations may change and be performed in other orderings.

FIG. 3 shows a process for creating and using a shortcut.

After a start operation, the process flows to operation 310, where a recording of a shortcut is started. For example, the recording may be started by selecting a user interface element. According to an embodiment, the recording is started from outside of an application before an application and associated actions from that application are recorded. For example, a user may start a recording from a start screen of a display of a mobile device. When the actions for the shortcut are being recorded an indicator may be displayed on the display screen (e.g. a red light may be displayed). According to an embodiment, when an action is not recordable (e.g. as determined by an application not registering the action as recordable through the API) the indicator may temporarily change states.

Moving to operation 320, actions are recorded. The actions may include a variety of actions. For example, the actions may include launching an application, performing actions within the application (e.g. opening/creating a document/message, addressing a message, accessing a data source, . . . ) and performing any other applications (e.g. launching another application, checking an availability of a data item, . . . ). According to an embodiment, an API is provided that allows applications to register the actions that are recordable. For example, an application may expose a subset of available actions instead of exposing all of the available actions that are associated with the application. The recording may be paused at one or more points during the recording of the actions. For example, the user may temporarily pause the recording while they perform actions that they do not want to include within the recording. The recorded actions may include actions that are associated with more than one application.

Flowing to operation 330, the actions may be edited. The editing may occur before/after creating the shortcut. The editing of the recording may include a variety of different actions. For example, the sequence of the actions may be changed, an action may be deleted, an action may be added, an action may be edited, a parameter associated with an action may be set/changed, and the like.

Transitioning to operation 340, a shortcut for the recorded actions is created. The shortcut may be associated with a hardware button and/or a software input. The user may select a location of a display of the shortcut. For example, the shortcut may be placed on a start screen or some other screen, within a menu, and the like. The shortcut may also be associated with a keyboard shortcut and/or a gesture input.

Moving to operation 350, the selection of the shortcut is received. For example, a user may select a shortcut using touch input and/or non-touch input. The shortcut is externally located from the application(s) that it affects. For instance, in the example illustrated in FIG. 2, a user selects the shortcut from a start screen that in turn launches the messaging application.

Flowing to operation 360, the recorded actions that are associated with the shortcut are performed.

The process then moves to an end operation and returns to processing other actions.

FIG. 4 illustrates a process for recording a shortcut.

After a start operation, the process 400 flows to operation 410, where an action is received. Generally, the action may be any action that is associated with interacting with one or more applications. The action may be an input that launches the application, selecting an option within an application, entering data, selecting data, editing data, moving data, and/or performing some other action. The input may include actions that occur outside of the operation of one or more applications and/or within the application(s).

Moving to decision operation 420, a determination is made as to whether or not the input/action is recordable. According to an embodiment, each application may determine the actions that are recordable by specifying the actions that are recordable through an API. For example, an application may define the recordable actions. According to another embodiment, each action is recordable. When the action is recordable, the process flows to operation 430. When the action is not recordable, the process flows to decision operation 440.

At operation 430, the action is recorded. The actions may be stored in one or more locations. For example, the actions may be temporarily stored in a volatile memory on the device and then stored in a non-volatile memory at a location on and/or off of the device.

At decision operation 440, a determination is made as to whether to continue recording actions for the shortcut. According to an embodiment, the recording is stopped in response to a user selecting a user interface element. When the recording is to be continued, the process returns to operation 410. When the recording is to be stopped, the process flows to operation 450.

At operation 450, the actions are stored and the shortcut is created. The shortcut and associated actions may be stored on the computing device where the recording occurred and/or at a different location (e.g. a network share).

The process then moves to an end operation and returns to processing other actions.

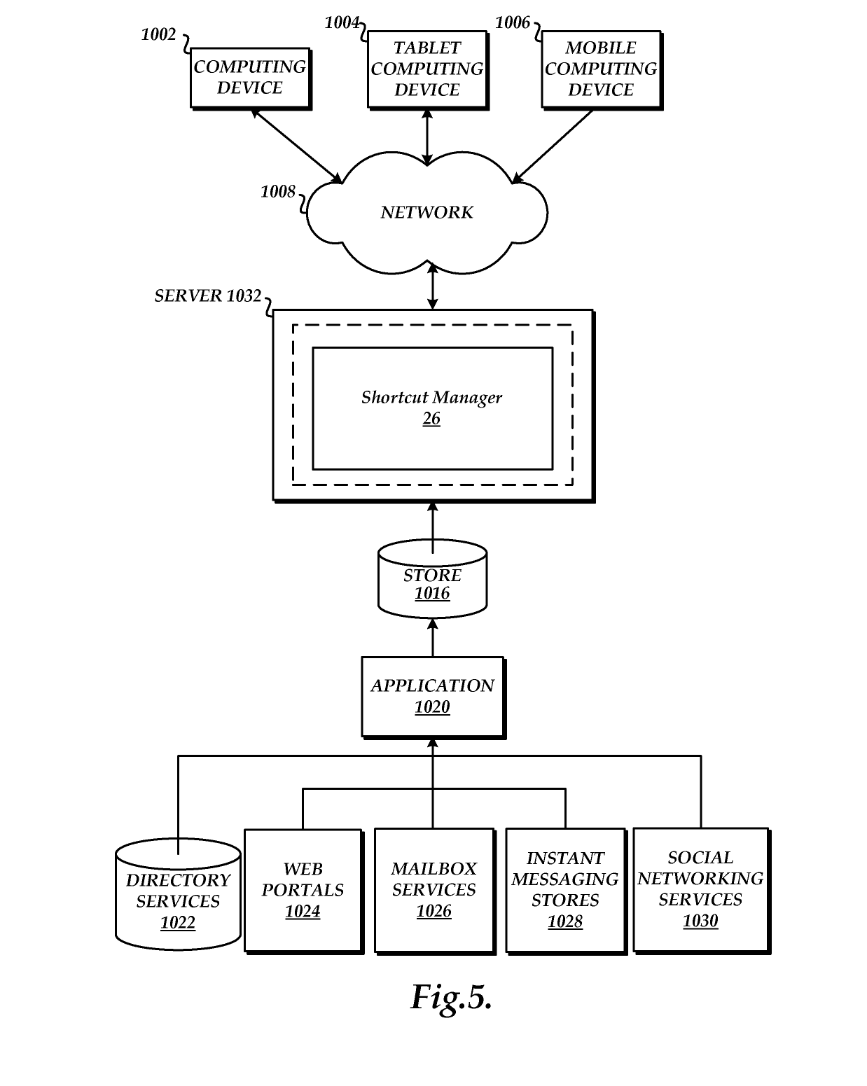

FIG. 5 illustrates a system architecture for creating and interacting with shortcuts, as described herein. Content used and displayed by the application (e.g. application 1020) and the shortcut manager 26 may be stored at different locations. For example, application 1020 may use/store data using directory services 1022, web portals 1024, mailbox services 1026, instant messaging stores 1028 and social networking sites 1030. The application 1020 may use any of these types of systems or the like. A server 1032 may be used to access shortcuts and to provide them to a client device and/or to perform actions at a network location. For example, server 1032 may perform actions that are associated with application 1020 and display results at a client (e.g. a browser or some other window). As one example, server 1032 may be a web server configured to provide productivity services (e.g. spreadsheet, presentation, word-processing, messaging, document collaboration, and the like) to one or more users. Server 1032 may use the web to interact with clients through a network 1008. Server 1032 may also comprise an application program. Examples of clients that may interact with server 1032 and a presentation application include computing device 1002, which may include any general purpose personal computer, a tablet computing device 1004 and/or mobile computing device 1006 which may include smart phones. Any of these devices may obtain content from the store 1016.

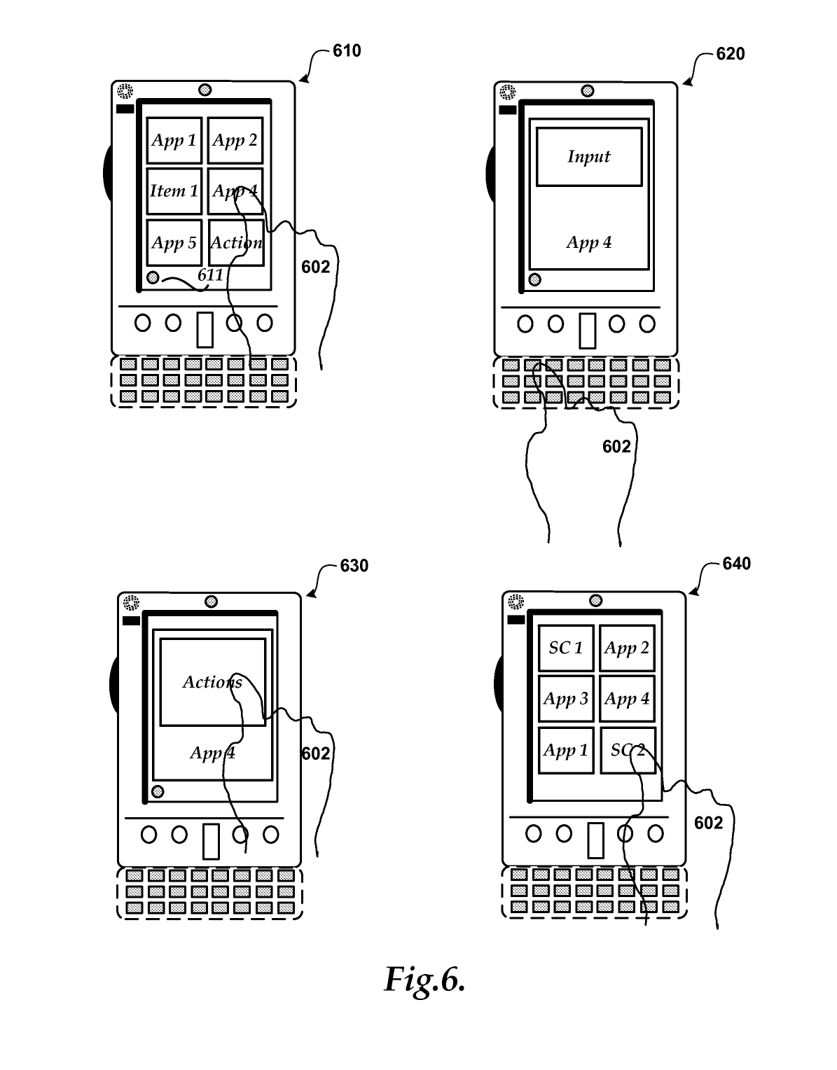

FIG. 6 shows exemplary displays that illustrate creating a shortcut.

Display 610 shows a user starting to record actions that are associated with a shortcut. Display 610 shows a mobile device that includes a display of applications, items and actions. For example, a user may launch an application from the display, open an item (e.g. a picture, contact, . . . ), and/or perform some other action (e.g. access a website, . . . ). Indicator 611 shows that actions are currently being recorded for the shortcut. In the current example, a user has selected App 4 using their hand 602.

Display 620 shows a display after App 4 has been launched. A user may record actions that are associated with the launched application. In the current example, a user is typing input using a keyboard that is associated with the mobile device. The input may be received using other means (e.g. touch input, copying/pasting, and the like). A user may record all/portion of their actions with the application. For example, a user may record the entry of some input, and not record entry of other input. As discussed above, the recording indicator may change its display when recording is paused and/or an action is not recordable by a user.

Display 630 shows a user recording more actions that are associated with App 4. In the current example, the user 602 is using touch input to perform an action(s) that is recorded.

Display 640, shows the recorded actions being associated with a shortcut (SC2). A user may edit a name and/or actions that are associated with the shortcut. Once the shortcut is created, the user may select the shortcut to perform the associated actions. While the recorded actions are illustrated with a single application, the recorded actions may be associated with more than one application.

FIG. 7 shows exemplary displays that illustrate editing a shortcut.

Display 710 shows a list of N actions that are associated with a shortcut. The actions may relate to different actions/inputs with one or more applications. A user may select one or more of the actions to edit. The editing of the shortcut may include one or more of: changing an ordering of the actions, changing a timing of a performance of an action, removing an action, adding an action, changing a value associated with the action, and the like.

Display 720 shows that Action 2 has been removed from the list of actions to perform and that Action 3 has been edited.

Display 730 shows selection of Action 1 for editing. In response to the selection of an action, any associated values, settings may be displayed for editing. For example, an action may be addressing a message and the values displayed may include each of the configured addresses that were recorded. The setting may relate to a priority of the message. Using the editing user interface, a user may change/delete/add any values/settings for the selected action.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method of creating and using a shortcut that groups actions to perform a task, comprising:
recording actions that are associated with an application including actions that occur outside of an execution of the application and actions that occur inside the execution of the application;
storing the recorded actions;
associating the recorded actions with a shortcut; and
receiving a selection of the shortcut externally from the application.

2. The method of claim 1, further comprising displaying the shortcut on a start screen of a mobile device.

3. The method of claim 2, further comprising exposing an Application Programming interface that exposes functionality for applications to expose actions that are recordable.

4. The method of claim 1, further comprising displaying a recording indicator when recording actions and updating a display of a recording indicator when an action that is associated with the application is not recordable.

5. The method of claim 1, further comprising displaying a user interface for editing a shortcut including the recorded actions.

6. The method of claim 1, wherein editing the shortcut comprises at least one of: changing an ordering of the recorded actions, editing one or more of the recorded actions, adding a recorded action, and changing a value that is associated with one or more of the recorded actions.

7. The method of claim 1, further comprising receiving a location to display the shortcut.

8. The method of claim 1, wherein recording the actions comprises recording a launching of the application and recording one or more actions that occur after the application has launched and are associated with the application.

9. The method of claim 1, further comprising determining when an action is recordable and when an action is not recordable.

10. A computer-readable medium having computer-executable instructions for creating and using a shortcut that groups actions to perform a task, comprising:
associating recorded actions that are associated with an application including actions that occur outside of an execution of the application and actions that occur inside the execution of the application with a shortcut;
storing the shortcut;
displaying the shortcut on a screen of a mobile device that also displays applications; and
receiving a selection of the shortcut that when selected performs the associated recorded actions.

11. The computer-readable medium of claim 10, further comprising exposing an Application Programming interface that exposes functionality for applications to expose actions that are recordable.

12. The computer-readable medium of claim 10, further comprising recording the actions based on user input and displaying a recording indicator when recording the actions.

13. The computer-readable medium of claim 10, further comprising displaying a user interface for editing a shortcut and the recorded actions.

14. The computer-readable medium of claim 10, wherein editing the shortcut comprises at least one of: changing a name of the shortcut, changing an ordering of the recorded actions, editing one or more of the recorded actions, adding a recorded action, and changing a value that is associated with one or more of the recorded actions.

15. The computer-readable medium of claim 10, further comprising receiving a location within the display of applications to display the shortcut.

16. The computer-readable medium of claim 10, wherein the recorded actions comprise an action for launching the application and an action performed within the application.

17. A system for creating and using a shortcut that groups actions to perform a task, comprising:
a display;
a network connection;
a processor and a computer-readable medium;
an operating environment stored on the computer-readable medium and executing on the processor; and
a process operating under the control of the operating environment and operative to perform actions, comprising:
associating recorded actions that are associated with an application including actions that occur outside of an execution of the application and actions that occur inside the execution of the application with a shortcut;
displaying the shortcut on a screen of a mobile device that also displays applications; and
receiving a selection of the shortcut that when selected performs the associated recorded actions.

18. The system of claim 17, further comprising exposing an Application Programming interface that exposes functionality for applications to expose actions that are recordable.

19. The system of claim 17, further comprising displaying a user interface for editing a shortcut and the recorded actions, wherein editing the shortcut comprises at least one of: changing a name of the shortcut, changing an ordering of the recorded actions, editing one or more of the recorded actions, adding a recorded action, and changing a value that is associated with one or more of the recorded actions.

20. The system of claim 17, wherein the recorded actions comprise an action for launching the application and an action performed within the application.
